(19) United States
(12) Patent Application Publication
(10) Pub. No.: US 2025/0144888 A1
(43) Pub. Date: May 8, 2025

(54) SEALING TOOL FOR SEALING A BASE INTO A SLEEVE

(71) Applicant: HERRMANN ULTRASCHALLTECHNIK GMBH & CO. KG, Karlsbad (DE)

(72) Inventor: Valentin BUCHTY, Ettlingen (DE)

(21) Appl. No.: 18/730,096

(22) PCT Filed: Mar. 1, 2023
(86) PCT No.: PCT/EP2023/055141

§ 371 Date: Jul. 22, 2024

(30) Foreign Application Priority Data
Mar. 21, 2022 (DE) 10 2022 106 575.8

(51) Int. Cl. B29C 65/08; B29C 65/78

(52) U.S. Cl. CPC B29C 65/081; B29C 65/7838; B29C 65/7847

(57) ABSTRACT

A sealing tool for sealing a base into a sleeve with a sonotrode and an anvil with an end face, the anvil having a cavity in the end face to accommodate the sleeve and base, the cavity having an inner surface section formed as a first sealing surface, the sonotrode having a section that can be guided into the cavity in a longitudinal direction and has a circumferential surface section formed as a second sealing surface, the sonotrode and anvil being movable relative to each other in a longitudinal direction between a starting position, in which the sonotrode is positioned outside the cavity, and a welding position, in which the sonotrode is positioned inside the cavity so that the two sealing surfaces are arranged opposite each other and a gap for accommodating the sleeve and base remains between the two sealing surfaces, wherein an inner surface section serving as a guide section adjoins the first sealing surface in the longitudinal direction.

### FIELD OF THE INVENTION

The present invention relates to a sealing tool for sealing a base into a sleeve. Furthermore, a method for joining a base with a sleeve is described.

### BACKGROUND OF THE INVENTION

In the production of containers, e.g., for holding liquids or bulk goods, a strip-shaped material is often first cut into a shell element, the so-called sleeve, and its edges are joined together to form a hollow cylinder. Other shapes, such as rectangular, square, or kidney shapes, are also possible.

A base is glued into the sleeve to close it on one side. The base can, for example, be circular, with the edge sections bent approximately 90° so that they are aligned roughly parallel to the shell element. The edge sections of the base are then glued to the shell element. The sleeve with the glued-in base can then serve as a container for liquids or bulk goods.

Instead of gluing the base into the sleeve, it was proposed in EP 1 819 506 B1 to seal the base into the sleeve using an ultrasonic tool.

For this purpose, a sonotrode and an anvil with an end face are used, whereby the anvil has a cavity in the end face to accommodate the sleeve and the base inserted into the sleeve. The cavity has an inner surface section formed as a first sealing surface, while the sonotrode has a section that can be guided into the cavity in a longitudinal direction and has a circumferential surface section formed as a second sealing surface. The cavity can completely penetrate the anvil so that the sleeve can be fed into the cavity from one side and the base from the other side.

The sonotrode and the anvil are moved relative to each other in a longitudinal direction between a starting position, in which the sonotrode is positioned outside the cavity, and a welding position, in which the sonotrode is positioned inside the cavity so that the two sealing surfaces are arranged opposite each other and a gap for accommodating the sleeve and the base remains between the two sealing surfaces. In the welding position, the sonotrode is excited with acoustic ultrasonic vibrations, so that the material positioned between the first and second sealing surfaces is welded. Usually, thermoplastic materials are used here. However, other materials, such as composites of thermoplastic and elastomeric materials, are also conceivable.

Especially in containers with relatively large volumes and dense filling materials, it can happen that the weld connection loosens over time and the filling material leaks from the container. This is undesirable.

### SUMMARY OF THE INVENTION

Starting from the described state of the art, it is therefore the object of the present invention to further develop a sealing tool of the aforementioned type in such a way that a secure sealing connection between the base and the sleeve can be ensured. In this context, a method for joining a sleeve and a base is described, which ensures a secure and durable connection even under high load.

With regard to the sealing tool, this object is achieved by providing that an inner surface section serving as a guide section adjoins the first sealing surface in the longitudinal direction, which is arranged closer to the sonotrode in the starting position than the first sealing surface.

This measure ensures that the base does not have to be connected to the sleeve at its outer end, but that the sleeve extends beyond the base. This means that the overhanging section of the sleeve can be crimped after sealing. The crimped section can then also be connected to the edge section of the base, so that it is connected to the sleeve material on both sides. By crimping, a part of the force exerted by the filling material on the base is transferred via the crimped section of the sleeve, which relieves the sealing connection.

In a preferred embodiment, it is provided that the first and/or second sealing surface forms an angle a with the longitudinal axis, which is greater than 0°, preferably between 5° and 35°, more preferably between 7° and 20°, and most preferably between 10° and 15°.

This measure ensures that a welding force can be exerted on the material positioned between the two sealing surfaces by the relative movement of the sonotrode with respect to the anvil in the direction of the longitudinal axis.

In a particularly preferred embodiment, both the first and the second sealing surfaces are inclined with respect to the longitudinal axis.

It is particularly advantageous if the gap between the first sealing surface and the second surface, into which the material to be welded is placed, has an uneven width. This can be achieved, for example, by forming the gap with a conical cross-section.

Thus, if the first and second sealing surfaces are formed flat, each forms a different angle with the longitudinal axis. A particularly preferred embodiment is one in which the angle formed by the second sealing surface with the longitudinal axis is greater than the angle formed by the first sealing surface with the longitudinal axis.

In another preferred embodiment, it is provided that the first sealing surface and/or the second sealing surface has a recess running in the longitudinal direction. This measure allows the sleeve, which consists of a strip-shaped material joined at its edges, to overlap at its edges, which improves the strength of the sleeve.

Due to the overlapping edge areas, however, the sleeve is somewhat thicker in this area than in all other areas. According to this embodiment, a corresponding recess is provided, into which the overlapping areas of the sleeve can be placed.

This recess can be formed either in the first sealing surface of the sonotrode or in the second sealing surface of the anvil. Alternatively, it is also possible for both the first and second sealing surfaces to have a corresponding recess, so that during the welding process, the bulge formed by the overlap lies partially in the recess of the first sealing surface and partially in the recess of the second sealing surface.

In another preferred embodiment, it is provided that the sonotrode has an end face aligned perpendicular to the longitudinal axis adjoining the first sealing surface, in which a channel opening is arranged, through which a vacuum can be applied to a base resting on the end face of the sonotrode.

This embodiment has the advantage that the base can be transported to the location where it is welded to the sleeve using the sonotrode. The base is placed on the end face of the sonotrode, so that the edge areas of the base, which are bent at approximately 90° relative to the base surface, rest against the first sealing surface.

To ensure that the base remains in position during the movement of the sonotrode and especially when the base is inserted into the sleeve, a channel opening is provided in the end face of the sonotrode, through which air can be drawn in, resulting in the base resting on the end face of the sonotrode being sucked in and held in place.

In another preferred embodiment, it is provided that the cavity of the anvil has an inner surface section serving as a holding section for the sleeve, in which a channel opening is arranged, through which a vacuum can be applied to a sleeve resting on the holding section.

This measure also facilitates the positioning of the sleeve on the inner surface of the anvil. By drawing air through the channel in the anvil, which opens in the holding section, the sleeve is sucked in and held firmly against the holding section of the anvil. In a preferred embodiment, the holding section adjoins the first sealing surface, so that the first sealing surface is arranged in the longitudinal direction between the holding section and the guide section.

In another embodiment, it is provided that the cavity in the longitudinal direction has adjacent inner surface sections with different inner diameters.

This measure allows individual inner surface sections to be used for guiding and holding the sleeve, while another inner surface section, namely the second sealing surface, is used for welding.

In another preferred embodiment, it is provided that the cavity of the anvil has an expanding cross-section on its side facing the sonotrode.

This facilitates the threading of the sonotrode into the cavity of the anvil. If, unexpectedly, the sonotrode is not perfectly positioned relative to the anvil, it will encounter the outwardly expanding section of the inner surfaces during movement from the starting position to the welding position and will then be guided into its desired position.

In another preferred embodiment, it is provided that the anvil is floatingly mounted in a plane perpendicular to the longitudinal direction. The floating mounting allows the anvil to yield to forces applied in a limited manner in the plane perpendicular to the longitudinal direction.

It is particularly advantageous if the anvil is designed in two parts, with the two parts arranged side by side in the longitudinal direction. Preferably, the part of the anvil that has the second sealing surface is floatingly mounted in a plane perpendicular to the longitudinal direction. The holding section is preferably not provided on the same part of the anvil on which the first sealing surface is mounted.

In another preferred embodiment, it is provided that at least the part of the anvil that has the second sealing surface consists of two separable members, which are arranged side by side in a plane perpendicular to the longitudinal direction. This measure allows at least one member to be moved away from the other after sealing the base in the sleeve to facilitate the removal of the processed material.

The described tools can be used in a method with the following steps:
A) Providing a sealing tool as just described,
B) Positioning the sleeve within the cavity so that a section of the sleeve rests against the guide section and another section of the sleeve rests against the first sealing surface,
C) Positioning the base on the sonotrode so that edge sections of the base rest against the second sealing surface, and
D) Positioning the sealing tool in the welding position and exciting the sonotrode with an ultrasonic vibration.

Thus, the base is not positioned directly at the end of the sleeve and connected to it, but somewhat further inside, so that an additional section of the sleeve extends beyond the sealing surface and is not welded to the base.

This has the advantage that in a further processing step, the outer section of the sleeve, i.e., the section of the sleeve that rested against the guide section of the anvil during the welding process in step D), can be bent so that it rests against the edge section of the base. In this position, the edge section is gripped on both sides by the sleeve. The bent section of the sleeve can then also be connected to the edge section of the base.

### BRIEF DESCRIPTION OF THE DRAWINGS

Further advantages, features, and applications will become apparent from the following description of some preferred embodiments and the associated figures. These show:

FIG. 1: an exploded view of a first embodiment of the invention,

FIG. 2: a sectional view of the embodiment of FIG. 1,

FIG. 3: a detail enlargement of the view of FIG. 2,

FIG. 4: a copy of the view of FIG. 3 with sleeve and base inserted, and

FIG. 5: an exploded view of a second embodiment of the invention.

### DETAILED DESCRIPTION OF THE INVENTION

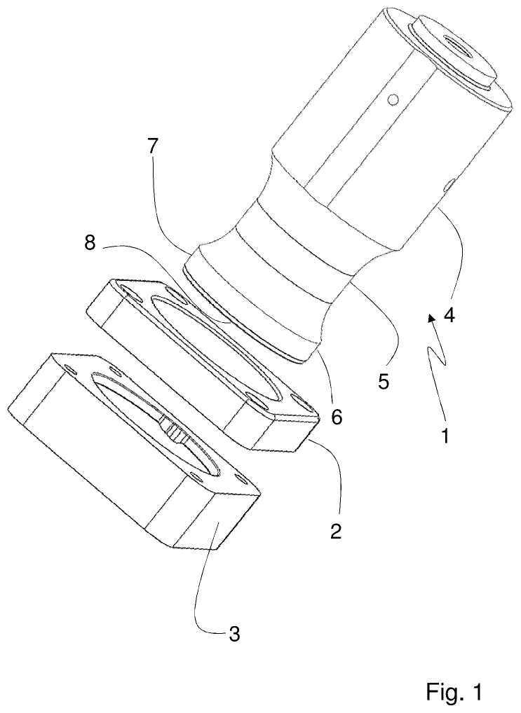

In FIG. 1, an exploded view of a first embodiment of a sealing tool according to the invention is shown. The sealing tool is intended for sealing a base into a sleeve. The sealing tool comprises a sonotrode 1 and an anvil 2, 3. In this embodiment, the anvil 2, 3 is designed in two parts and comprises a first part 2 and a second part 3, which can be screwed together.

The anvil 2, 3 has a cavity that extends completely through the anvil.

The sonotrode 1 has an end face 8, which is bounded by a second sealing surface 7 forming a circumferential surface section of the sonotrode. A cylindrical circumferential surface section 6 adjoins the second sealing surface 7, which in turn is connected to another cylindrical circumferential surface section 4 via a constricted section 5.

The end face 8 of the sonotrode has several vacuum holes 9, through which a base to be sealed into a sleeve using the sealing tool can be sucked in and thereby held.

In the shown embodiment, the sonotrode 1 is rotationally symmetrical about its longitudinal axis. The sonotrode 1 can be moved relative to the anvil 2, 3 in the longitudinal direction, i.e., along the longitudinal axis, between a starting position, in which the sonotrode is positioned outside the cavity, and a welding position, in which the sonotrode is positioned inside the cavity.

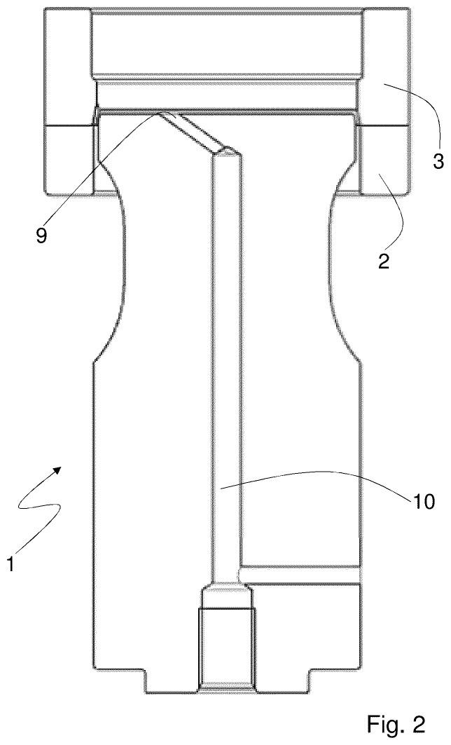

In FIG. 2, a sectional view of the embodiment of FIG. 1 in the welding position is shown. One of the vacuum holes 9 is visible, connected to a central hole 10, through which air can be drawn. In the welding position, the sonotrode 1 and the anvil 2, 3 are arranged so that they do not touch.

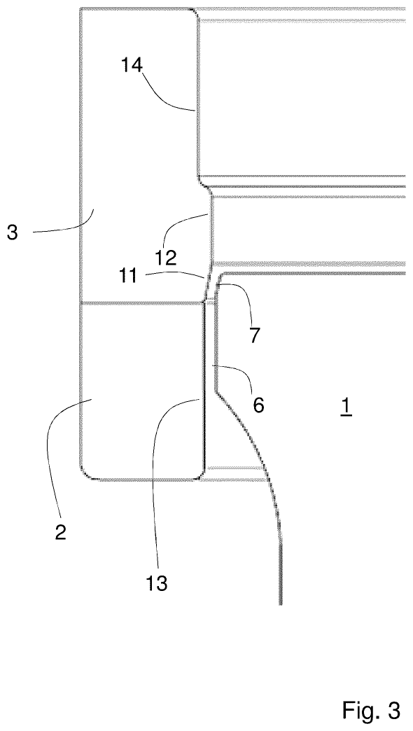

In FIG. 3, a detail enlargement of FIG. 2 is shown. It can be seen that the cavity of anvil part 3 has an inner surface section formed as the first sealing surface 11. In the welding position, the sonotrode 1 is positioned inside the cavity so that the two sealing surfaces, i.e., the first sealing surface 11 of anvil part 3 and the second sealing surface 7 of sonotrode 1, are arranged opposite each other and a gap for accommodating the sleeve and the base remains between the two sealing surfaces.

In the longitudinal direction, an inner surface section serving as a guide section 13 adjoins the first sealing surface 11 of the anvil. The guide section 13 is positioned closer to the sonotrode 1 in the starting position than the first sealing surface 11. As described in more detail below, the guide section 13 is intended to guide a section of the sleeve that extends beyond the base.

The sonotrode 1 has an outer surface section 6 adjoining the second sealing surface 7, which is positioned opposite the guide section 13 and spaced from it in the welding position.

In the longitudinal direction on the opposite side of the first sealing surface 11, a holding section 12 is provided, which is essentially cylindrical and has an inner diameter approximately equal to the outer diameter of the sleeve. Another inner surface section 14, which has a larger inner diameter than the holding section 12, adjoins the holding section 12.

The first sealing surface 11 forms an angle greater than 0° and preferably between 10° and 15° with the longitudinal axis. Similarly, the second sealing surface 7 also forms an angle greater than 0° and preferably between 10° and 15° with the longitudinal axis. In the shown embodiment, the angle formed by the second sealing surface with the longitudinal axis is greater than the angle formed by the first sealing surface with the longitudinal axis. The difference in the angles in the shown embodiment is only 1°. The different angles result in the gap width between the first sealing surface 11 and the second sealing surface 7 not being constant.

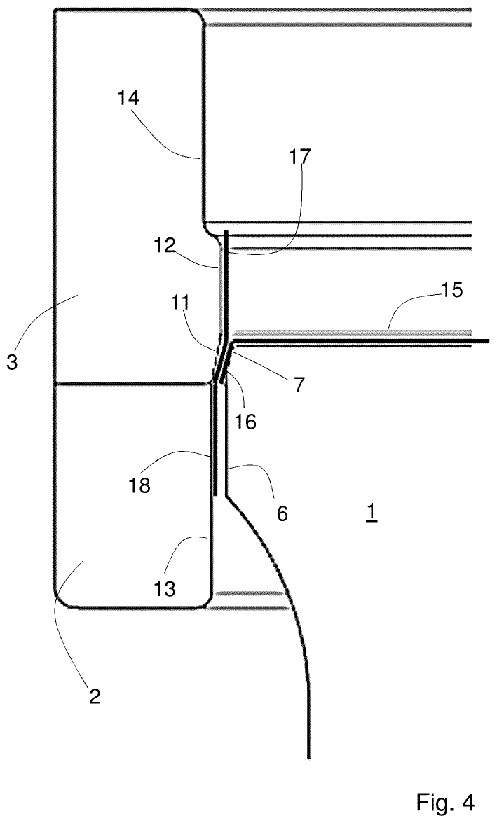

The function of the involved inner and outer surface sections becomes clear from FIG. 4, which essentially corresponds to the view of FIG. 3, but here additionally schematically shows a base element 15 and a sleeve 17. The base element 15 is circular in the shown example and rests on the end face of the sonotrode. The outer ring section 16 of the base element 15 is bent and rests against the second sealing surface 7.

The sleeve 17 rests against the inner contour of the anvil 2,3. In the welding position shown in the figure, if the sonotrode 1 is excited with ultrasonic vibrations, the outer ring section 16, which rests against the second sealing surface 7, and the section of the sleeve 17, which rests against the first sealing surface 11, will be melted together. Due to the different angles formed by the first and second sealing surfaces 7 and 11 with the longitudinal axis, melted material will arrange itself wedge-shaped within the gap between the two sealing surfaces, thereby pressing the base 15 and sleeve 17 into the correct position.

It can be seen that the sleeve 17 is inserted into the anvil so that a section 18 of the sleeve 17 extends beyond the first sealing surface 11. To ensure that the section 18 is oriented approximately parallel to the longitudinal axis and thus approximately perpendicular to the base 15, the guide section 13 is provided, against which the section 18 of the sleeve 17 rests.

The section 18 of the sleeve is bent in a further processing step and also sealed with the ring-shaped section 16 of the base, so that the bent ring-shaped section 16 of the base 15 is enclosed on both sides by the sleeve 17.

Even though not shown in this embodiment, the inner surface of the anvil may have a recess running essentially in the longitudinal direction, in which a weld seam of the sleeve can be accommodated. The sleeve is often made from a rectangular sheet of material, with opposite edges of the rectangular cutout glued or welded together. As the material at the weld seam is somewhat thicker, the weld seam can then be placed into the corresponding recess provided.

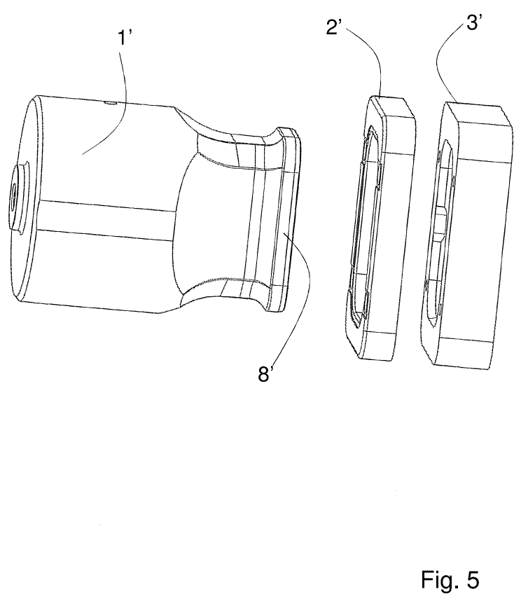

In FIG. 5, an exploded view of a second embodiment of the invention is shown. This differs from the embodiment shown in FIG. 1 only in that the shape of the end face 8′ of the sonotrode 1′ is not circular but essentially rectangular. Accordingly, the inner contour of the anvil 2′,3′ has been adjusted. This tool is intended for sealing rectangular bases into corresponding sleeves.

### LIST OF REFERENCE SIGNS

1, 1′ Sonotrode
2, 2′, 3, 3′ Anvil
4, 6 Circumferential surface section
5 Section
7 Sealing surface
8, 8′ End face of the sonotrode
9 Vacuum holes
10 Central hole
11 First sealing surface
12 Holding section
13 Guide section
14 Inner surface section
15 Base
16 Section
17 Sleeve
18 Section

What is claimed is:

1. A sealing tool for sealing a base into a sleeve with a sonotrode and an anvil with an end face,
the anvil having a cavity in the end face to accommodate the sleeve and base,
the cavity having an inner surface section formed as a first sealing surface,
the sonotrode having a section that can be guided into the cavity in a longitudinal direction and has a circumferential surface section formed as a second sealing surface,
the sonotrode and anvil being movable relative to each other in a longitudinal direction between a starting position, in which the sonotrode is positioned outside the cavity, and
a welding position, in which the sonotrode is positioned inside the cavity so that the two sealing surfaces are arranged opposite each other and a gap for accommodating the sleeve and base remains between the two sealing surfaces,
wherein an inner surface section serving as a guide section adjoins the first sealing surface in the longitudinal direction, which is arranged closer to the sonotrode in the starting position than the first sealing surface.

2. The sealing tool according to claim 1, wherein the first and/or second sealing surface forms an angle a with the longitudinal axis, which is greater than 0°, preferably between 5° and 35°, more preferably between 7° and 20°, and most preferably between 10° and 15°.

3. The sealing tool according to claim 1, wherein the first and second sealing surfaces each form an angle a with the longitudinal axis, which is greater than 0°, the first and second sealing surfaces forming different angles with the longitudinal axis so that the gap has a conical cross-section, preferably the angle formed by the second sealing surface with the longitudinal axis being greater than the angle formed by the first sealing surface with the longitudinal axis.

4. The sealing tool according to claim 1, wherein the first and/or second sealing surface has a recess running in the longitudinal direction.

5. The sealing tool according to claim 1, wherein the sonotrode has an end face aligned perpendicular to the longitudinal axis adjoining the first sealing surface, in which a channel opening is arranged, through which a vacuum can be applied to a base resting on the end face of the sonotrode.

6. The sealing tool according to claim 1, wherein the cavity of the anvil has an inner surface section serving as a holding section for the sleeve, in which a channel opening is arranged, through which a vacuum can be applied to a sleeve resting on the holding section.

7. The sealing tool according to claim 1. wherein the cavity in the longitudinal direction has adjacent inner surface sections with different inner diameters.

8. The sealing tool according to claim 1, wherein the cavity of the anvil has an expanding cross-section on its side facing the sonotrode.

9. The sealing tool according to claim 1, wherein the anvil is floatingly mounted in a plane perpendicular to the longitudinal direction.

10. The sealing tool according to claim 1, wherein the anvil is designed in two parts, with the two parts arranged side by side in the longitudinal direction, the part of the anvil having the second sealing surface being floatingly mounted in a plane perpendicular to the longitudinal direction.

11. The sealing tool according to claim 10, wherein at least the part of the anvil having the second sealing surface consists of two separable members, which are arranged side by side in a plane perpendicular to the longitudinal direction.

12. The sealing tool according to claim 2, wherein the first and second sealing surfaces each form an angle a with the longitudinal axis, which is greater than 0°, the first and second sealing surfaces forming different angles with the longitudinal axis so that the gap has a conical cross-section, preferably the angle formed by the second sealing surface with the longitudinal axis being greater than the angle formed by the first sealing surface with the longitudinal axis.

13. The sealing tool according to claim 12, wherein the first and/or second sealing surface has a recess running in the longitudinal direction.

14. The sealing tool according to claim 13, wherein the sonotrode has an end face aligned perpendicular to the longitudinal axis adjoining the first sealing surface, in which a channel opening is arranged, through which a vacuum can be applied to a base resting on the end face of the sonotrode.

15. The sealing tool according to claim 14, wherein the cavity of the anvil has an inner surface section serving as a holding section for the sleeve, in which a channel opening is arranged, through which a vacuum can be applied to a sleeve resting on the holding section.

16. The sealing tool according to claim 15, wherein the cavity in the longitudinal direction has adjacent inner surface sections with different inner diameters.

17. The sealing tool according to claim 16, wherein the cavity of the anvil has an expanding cross-section on its side facing the sonotrode.

18. The sealing tool according to claim 17, wherein the anvil is floatingly mounted in a plane perpendicular to the longitudinal direction.

19. The sealing tool according to claim 18, wherein the anvil is designed in two parts, with the two parts arranged side by side in the longitudinal direction, the part of the anvil having the second sealing surface being floatingly mounted in a plane perpendicular to the longitudinal direction.

20. The sealing tool according to claim 19, wherein at least the part of the anvil having the second sealing surface consists of two separable members, which are arranged side by side in a plane perpendicular to the longitudinal direction.
